(19) United States
(12) Patent Application Publication
(10) Pub. No.: US 2026/0002775 A1
(43) Pub. Date: Jan. 1, 2026

(54) OPTICAL MEASURING DEVICE

(71) Applicant: Samsung Electronics Co., Ltd., Suwon-si (KR)

(72) Inventors: Jiyoung Chu, Suwon-si (KR); Hyungjin Kim, Suwon-si (KR); Minhwan Seo, Suwon-si (KR); Jungchul Lee, Suwon-si (KR); Dongyoon Koo, Suwon-si (KR); Sangwoo Bae, Suwon-si (KR); Sung Min Ahn, Suwon-si (KR); Seungyeol Oh, Suwon-si (KR); Jungyu Lee, Suwon-si (KR)

(21) Appl. No.: 18/987,549

(22) Filed: Dec. 19, 2024

(30) Foreign Application Priority Data
Jun. 26, 2024 (KR) 10-2024-0083567

(51) Int. Cl. G01B 11/27; G01B 11/16

(52) U.S. Cl. CPC G01B 11/272; G01B 11/16

(57) ABSTRACT

An optical measuring device includes a first optical system for measuring a first alignment mark of a first object using a first illumination light, and for measuring a second alignment mark of a second object facing the first object using a second illumination light; and a second optical system for measuring the parallelism of the first object and the second object using a reference light and a measuring light. The first optical system includes a first dichroic mirror arranged in the first light path of the first illumination light; a second dichroic mirror arranged in the second light path of the second illumination light; and a folding mirror arranged in the first light path and the second light path. The second optical system includes the first dichroic mirror, the second dichroic mirror, and the folding mirror arranged on a third light path of the measuring light.

### CROSS-REFERENCE TO RELATED APPLICATION

This application claims priority to and the benefit of Korean Patent Application No. 10-2024-0083567 filed in the Korean Intellectual Property Office on Jun. 26, 2024, the entire contents of which are incorporated herein by reference.

### FIELD

The present disclosure relates to an optical measuring device.

### BACKGROUND

The semiconductor industry aims to down-size, reduce weight, and reduce thickness of semiconductor packages mounted on electronic devices, while simultaneously pursuing a higher speed, multi-functionality, and larger capacity in response to a down-size and lightweight requirements for electronic devices. Accordingly, stacked semiconductor devices (e.g., Three Dimensional Integrated Circuit (3DIC) or high bandwidth memory (HBM)) that may store more data and transmit data at faster speeds are being researched. These stacked semiconductor devices may be manufactured based on a CoW (Chip-on-Wafer) process technology.

In CoW, in order to directly bond the semiconductor die to the wafer by using bumps and bonding pads, and to accurately bond numerous bumps and bonding pads, measurements of alignment and parallelism between the semiconductor die and the wafer may be performed before bonding the bumps and the bonding pads. However, conventionally, the measurement of the alignment and the measurement of the parallelism may be performed using separate devices, separate systems, or separate processes, increasing time for the entire measurement to be completed. Accuracy of the measured alignment and parallelism may also be low due to factors such as errors in the measuring position and differences in the measuring time when replacing an optical system, changes of vibration or temperature applied by an imaging optical system and a parallelism optical system, etc., which may cause problems.

### SUMMARY

An optical measuring device includes an imaging optical system and a parallelism optical system and may measure the alignment and the parallelism of objects at the same position and simultaneously (or sequentially).

An optical measuring device according to an embodiment includes a first optical system configured to measure a first alignment mark of a first object using first illumination light, and to measure a second alignment mark of a second object facing the first object using second illumination light; and a second optical system configured to measure parallelism of the first object and the second object using a reference light and a measuring light. The first optical system includes a first dichroic mirror positioned in a first light path of the first illumination light; a second dichroic mirror positioned in a second light path of the second illumination light; and a folding mirror positioned in the first light path and in the second light path. The second optical system includes the first dichroic mirror, the second dichroic mirror, and the folding mirror positioned in a third light path of the measuring light.

An optical measuring device according to an embodiment includes a first optical system configured to measure a first alignment mark of a first object using first illumination light, and to measure a second alignment mark of a second object facing a first object using second illumination light; and a second optical system configured to measure parallelism of the first object and the second object using a reference light and a measuring light. The first optical system and the second optical system include a first dichroic mirror configured to transmit the first illumination light and reflect the measuring light; a second dichroic mirror configured to transmit the second illumination light and reflect the measuring light; and a folding mirror between the first dichroic mirror and the second dichroic mirror. The folding mirror is configured to reflect the first illumination light transmitted through the first dichroic mirror toward the first alignment mark, to reflect the second illumination light transmitted through the second dichroic mirror toward the second alignment mark, to reflect the measuring light reflected from the first dichroic mirror toward the first object, and to reflect the measuring light reflected from the second dichroic mirror toward the second object.

An optical measuring device according to an embodiment includes a first optical system configured to measure alignment of a first object and a second object facing the first object; and a second optical system configured to measure parallelism of the first object and the second object. The first optical system includes an illumination element configured to emit illumination light having a first wavelength; a first polarization beam splitter configured to split the illumination light into first illumination light incident on the first object and second illumination light incident on the second object, and configured to direct the first illumination light reflected from the first object and the second illumination light reflected from the second object into a common light path; a first reflection unit, a first wavelength plate, a first lens, and a first dichroic mirror positioned in a first light path of the first illumination light; a second reflection unit, a second wavelength plate, a second lens, and a second dichroic mirror positioned in a second light path of the second illumination light; and a folding mirror positioned in the first light path of the first illumination light and in the second light path of the second illumination light, and positioned between the first dichroic mirror and the second dichroic mirror. The second optical system includes a light source configured to emit polarized light having a second wavelength; a second polarization beam splitter configured to split the polarized light into a reference light and a measuring light, and positioned in a third light path of the measuring light; a first reflection mirror positioned in the third light path, and on a first surface of the second polarization beam splitter; a third wavelength plate positioned in the third light path, and between the first surface of the second polarization beam splitter and the first reflection mirror; the first dichroic mirror positioned in the third light path and on a second surface opposite to the first surface of the second polarization beam splitter, wherein the first dichroic mirror is shared with the first optical system; a fourth wavelength plate positioned in the third light path, and between the second surface of the second polarization beam splitter and the first dichroic mirror; the folding mirror positioned in the third light path, wherein the folding mirror is shared with the first optical system; a third polarization beam splitter positioned in the third light path, and on a third surface adjacent to the first surface of the second polarization beam splitter; a second reflection mirror positioned in the third light path, and on a first surface of the third polarization beam splitter; a fifth wavelength plate positioned in the third light path, and between the first surface of the third polarization beam splitter and the second reflection mirror; the second dichroic mirror positioned in the third light path and on a second surface opposite to the first surface of the third polarization beam splitter, where the second dichroic mirror is shared with the first optical system; and a sixth wavelength plate positioned in the third light path and between the second surface of the third polarization beam splitter and the second dichroic mirror

By providing the optical measuring device that includes the (first) imaging optical system and the (second) parallelism optical system, the alignment and the parallelism of the objects may be measured at the same position and simultaneously. This may shorten the time that may be required to measure the alignment and the parallelism of the objects. In addition, the alignment and the parallelism of the objects may be measured without being affected by factors such as a replacement of the optical system, error in the measuring position, and difference in the measuring time, such that a high level of measuring reliability of the alignment and the parallelism may be secured and bonding accuracy of the objects may be increased.

At least one of the imaging optical system and parallelism optical system of an optical measuring device may be designed or otherwise configured to have a common light path. As a result, compared to a case of designing or configuring light paths differently, the alignment and the parallelism may be measured more accurately by reducing or minimizing environmental changes, such as physical vibration and temperature changes that may affect the optical measuring device.

The illumination light used in the imaging optical system of the optical measuring device may be split into two illumination lights, and both illumination lights may be used to measure the alignment between the objects. As a result, the loss of light within the imaging optical system may be reduced or minimized, and heat generated within the imaging optical system may be reduced or minimized, thereby increasing the stability of the imaging optical system.

The parallelism of the objects may be measured without being affected by the slope of the optical measuring device.

The deformation of the object may be measured by the parallelism optical system of the optical measuring device.

### BRIEF DESCRIPTION OF THE DRAWINGS

FIG. 1 is a view showing an optical measuring device that measures a first object and a second object.

FIG. 2 is a view showing an optical measuring device according to an embodiment.

FIG. 3 is a view showing an imaging optical system according to an embodiment.

FIG. 4 is a view showing an arrangement of a polarization beam splitter and a prism of an imaging optical system.

FIG. 5 is a view showing a parallelism optical system according to an embodiment.

FIG. 6 is a top plan view showing a parallelism optical system according to an embodiment.

FIG. 7 is a view showing a measuring result of a parallelism optical system according to an embodiment.

FIG. 8 is a view showing a measuring result of a parallelism optical system according to an embodiment.

FIG. 9 is a view showing a measuring result of a parallelism optical system according to an embodiment.

FIG. 10 is a view showing a measuring result of a parallelism optical system according to an embodiment.

FIG. 11 is a view showing a measuring result of a parallelism optical system according to an embodiment.

FIG. 12 is a view showing an imaging optical system and a parallelism optical system according to an embodiment.

### DETAILED DESCRIPTION OF EMBODIMENTS

Hereinafter, examples of the present disclosure will be described in detail with reference to the attached drawings so that the person of ordinary skill in the art may easily implement the present disclosure. However, the present disclosure may be modified in various ways and is not limited to the examples described herein.

In the drawings, some elements are omitted for simplicity of explanation, and like reference numerals designate like elements throughout the specification. The terms “first,” “second,” etc., may be used herein merely to distinguish one component, layer, direction, etc. from another. The term “and/or” includes any and all combinations of one or more of the associated listed items.

The size and thickness of the configurations are optionally shown in the drawings for convenience of description, and the present disclosure is not limited to the drawings.

In addition, unless explicitly described to the contrary, the word “comprise” and variations such as “comprises” or “comprising” will be understood to imply the inclusion of stated elements but not the exclusion of any other elements.

Further, in this specification, the word “on a plane” or “in plan view” means viewing a target portion from the top, and the word “on a cross section” means viewing a cross section formed by vertically cutting a target portion from the side.

Hereinafter, an optical measuring device 10 including an imaging optical system (also referred to as a first optical system) 100 and a parallelism optical system (also referred to as a second optical system) 200 according to an embodiment will be described with reference to drawings.

Stacked semiconductor devices are manufactured by directly bonding a semiconductor die to another semiconductor die or a wafer based on a CoC (Chip-on-Chip) or a CoW (Chip-on-Wafer) process technology. Bumps and bonding pads are used as connection members for a direct bonding, and may be critical to accurately bond the bumps and the bonding pads without error to ensure a bonding accuracy between objects, such as semiconductor dies and/or wafers. By placing a parallelism optical system between the semiconductor dies or between the semiconductor die and the wafer to measure the parallelism of the objects, and by placing an imaging optical system between the semiconductor dies or between the semiconductor die and the wafer to measure the alignment between the objects, the parallelism and the alignment between the objects may be adjusted and then a bonding process of the semiconductor dies or a bonding process between the semiconductor die and the wafer may be performed.

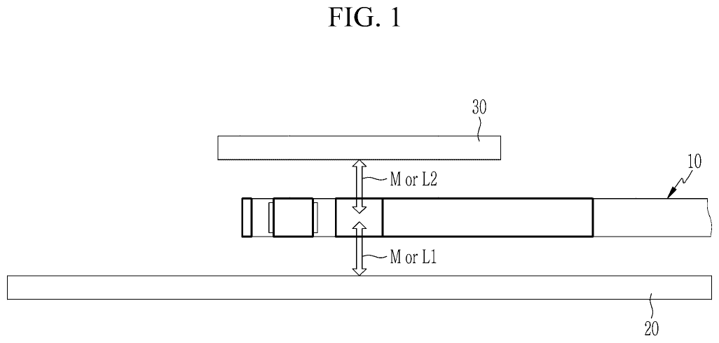

FIG. 1 is a view showing an optical measuring device 10 of measuring a first object 20 and a second object 30.

Referring to FIG. 1, the optical measuring device 10 may be disposed between the first object 20 and the second object 30 to measure the alignment between the first object 20 and the second object 30 and to measure the parallelism of the first object 20 and the second object 30. The optical measuring device 10 may measure the alignment between the first object 20 and the second object 30 by using a first illumination light L1 and a second illumination light L2. The optical measuring device 10 may measure the parallelism of the first object 20 and the second object 30 by using a measuring light M. In an embodiment, the first object 20 may include a semiconductor wafer or a semiconductor die. In an embodiment, the second object 30 may include a semiconductor die. The first object 20 may include a first alignment mark, and the second object 30 may include a second alignment mark. When the measurement is performed by the optical measuring device 10, the position of the first object 20 may be fixed with respect to the second object 30. When the measurement is performed by the optical measuring device 10, the position of the second object 30 may be fixed with respect to the first object 20.

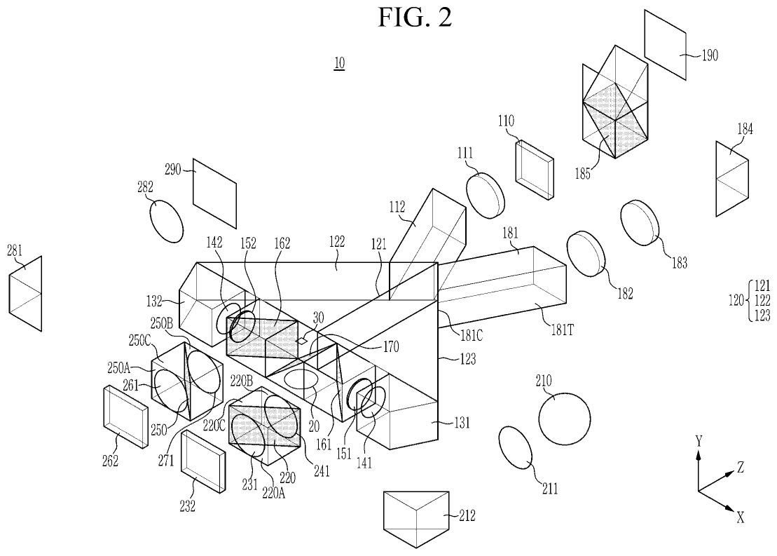

FIG. 2 is a view showing an embodiment of an optical measuring device 10.

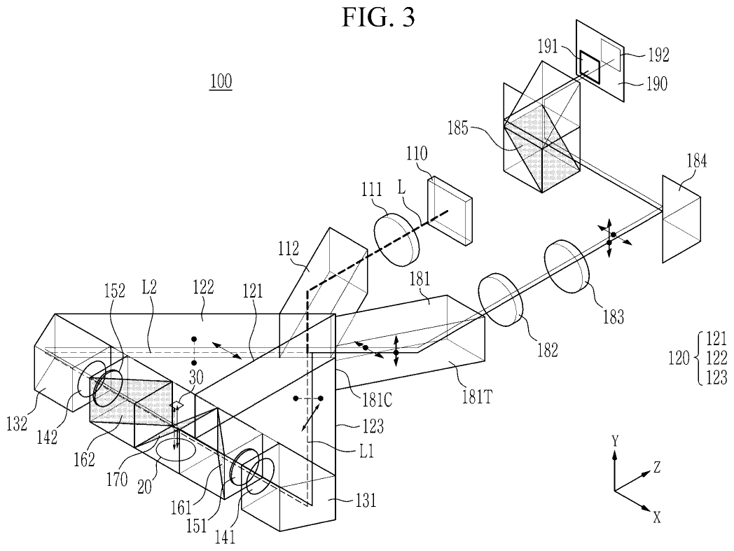

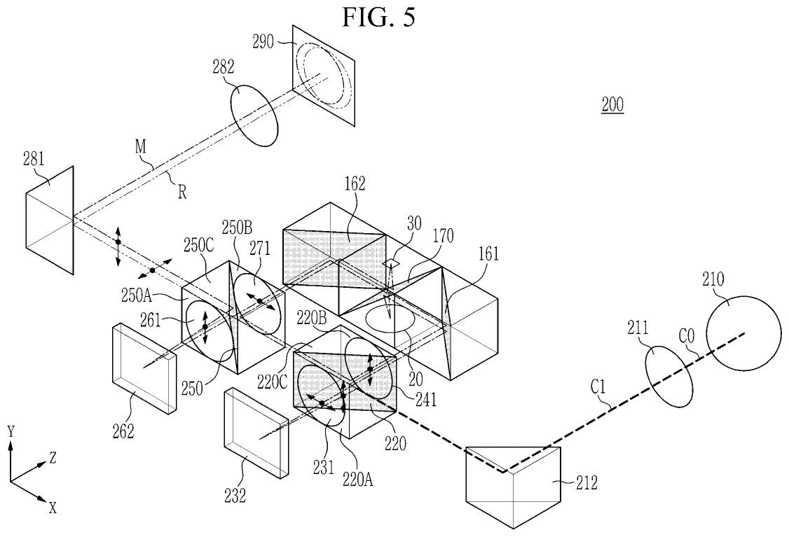

Referring to FIG. 2, the optical measuring device 10 may include an imaging optical system (a first optical system; 100; referring to FIG. 3) and a parallelism optical system (a second optical system; 200; referring to FIG. 5).

The imaging optical system 100 may include an illumination element 110, a lens 111, a first prism 112, a first polarization beam splitter 120, a first reflection unit 131, a second reflection unit 132, a first wavelength plate 141, a second wavelength plate 142, a first lens 151, a second lens 152, a first dichroic mirror 161, a second dichroic mirror 162, a folding mirror 170, a second prism 181, a third lens 182, a tube lens 183, a first mirror 184, a fourth polarization beam splitter 185, and a first light detector 190.

The illumination element 110 generates the illumination light (L; referring to FIG. 3). The illumination element 110 may include a light guide member that guides the illumination light L and a collimator lens for converting the illumination light L into a parallel light. In an embodiment, the illumination light L generated by the illumination element 110 may include a white light or a monochromatic light. In an embodiment, the illumination light L may have a first wavelength 21.

The lens 111 is disposed between the illumination element 110 and the first prism 112. The lens 111 collects the illumination light L from the illumination element 110 and transmits it to the first prism 112. The first prism 112 is disposed between the lens 111 and the first polarization beam splitter 120. The first prism 112 transmits the illumination light L from the lens 111 to the first polarization beam splitter 120. In another embodiment, the first prism 112 may be replaced with a mirror.

The first polarization beam splitter 120 may split the illumination light L into a first illumination light (L1; referring to FIG. 3) incident on the first object 20 and a second illumination light (L2; referring to FIG. 3) incident on the second object 30, and direct the first illumination light L1 reflected from the first object 20 and the second illumination light L2 reflected from the second object 30 into a common light path. The first polarization beam splitter 120 may include a polarization beam splitting surface 121, a third prism 122, and a fourth prism 123. The polarization beam splitting surface 121 is disposed between the third prism 122 and the fourth prism 123 in the X direction (a first horizontal direction; −X direction is also defined as the X direction). The polarization beam splitting surface 121 converts the polarization state of the illumination light L that reaches the polarization beam splitting surface 121. The polarization beam splitting surface 121 splits the illumination light L into a P polarization (a horizontal direction component) and a S polarization (a vertical direction component). The polarization beam splitting surface 121 transmits the P polarization (the horizontal direction component) and reflects the S polarization (the vertical direction component). The third prism 122 may have a shape of a right triangle. In an embodiment, the third prism 122 may include a 45° prism. The third prism 122 receives the illumination light L from the first prism 112 and may include a first surface opposing a right angle, a second surface in contact with the polarization beam splitting surface 121, and a third surface in contact with the second reflection unit 132. The fourth prism 123 may have the shape of a right triangle. In an embodiment, the fourth prism 123 may include a 45° prism. The fourth prism 123 may include a first surface opposing a right angle, a second surface in contact with the polarization beam splitting surface 121, and a third surface in contact with the first reflection unit 131.

The first reflection unit 131 is disposed on the third surface of the fourth prism 123. The first reflection unit 131 reflects the incident light according to the moving (or propagation) direction of the light. The second reflection unit 132 is disposed on the third surface of the third prism 122. The second reflection unit 132 reflects the incident light according to the moving direction of the light.

The first wavelength plate 141 is disposed between the first reflection unit 131 and the first lens 151 in the X direction (the first horizontal direction). The first wavelength plate 141 generates a phase delay between an ordinary axis and an extraordinary axis of light passing through the first wavelength plate 141. The first wavelength plate 141 converts the polarization state of light passing through the first wavelength plate 141. For the first wavelength plate 141, the (longer) fast axis may be set to a 45° direction, or the (shorter) slow axis may be set to a 45° direction. The second wavelength plate 142 is disposed between the second reflection unit 132 and the second lens 152 in the X direction (the first horizontal direction). The second wavelength plate 142 generates a phase delay between the ordinary axis and the extraordinary axis of light passing through the second wavelength plate 142. The second wavelength plate 142 converts the polarization state of light passing through the second wavelength plate 142. For the second wavelength plate 142, the fast axis may be set to a 45° direction, or the slow axis may be set to a 45° direction. In an embodiment, the first wavelength plate 141 and the second wavelength plate 142 may include a ¼ wavelength plate, respectively. The ¼ wavelength plate generates the phase delay of (n+½)π radian between the ordinary axis and the extraordinary axis. Here n is an integer. The ¼ wavelength plate may convert a linear polarization with an ellipticity (ε) of 0 into a circular polarization with an ellipticity (ε) of 1, and a circular polarization with an ellipticity (ε) of 1 into a linear polarization with an ellipticity (ε) of 0.

The first lens 151 is disposed between the first wavelength plate 141 and the first dichroic mirror 161 in the X direction (the first horizontal direction). The first lens 151 collects the light and transmits the light according to the moving direction of the light. The second lens 152 is disposed between the second wavelength plate 142 and the second dichroic mirror 162 in the X direction (the first horizontal direction). The second lens 152 collects the light and transmits the light according to the moving direction of the light.

The first dichroic mirror 161 is disposed between the first lens 151 and the folding mirror 170 in the X direction (the first horizontal direction). The first dichroic mirror 161 is disposed on the third surface of the fourth prism 123. The second dichroic mirror 162 is disposed between the second lens 152 and the folding mirror 170 in the X direction (the first horizontal direction). The second dichroic mirror 162 is disposed on the third surface of the third prism 122. A dichroic mirror may selectively reflect light in a predetermined wavelength region, so using the dichroic mirror may separate light according to a wavelength. The first dichroic mirror 161 transmits light with the first wavelength 21. The second dichroic mirror 162 transmits light with the first wavelength 21.

The folding mirror 170 is disposed between the first dichroic mirror 161 and the second dichroic mirror 162 in the X direction (the first horizontal direction). The folding mirror 170 converts the optical axis of light incident on the folding mirror 170 by 90°. The folding mirror 170 reflects the light transmitted through the first dichroic mirror 161 in the vertical lower direction to be directed to the first object 20, and transmits the light reflected from the first object 20 to the first dichroic mirror 161. The folding mirror 170 reflects the light transmitted through the second dichroic mirror 162 in the vertical upper direction to be directed to the second object 30, and transmits the light reflected from the second object 30 to the second dichroic mirror 162. In an embodiment, the folding mirror 170 may include a 45° mirror.

The second prism 181 is disposed between the first polarization beam splitter 120 and the third lens 182. The second prism 181 is disposed on the first surface of the fourth prism 123. The second prism 181 transmits the light from the first polarization beam splitter 120 to the third lens 182. In another embodiment, the second prism 181 may be replaced with a mirror.

The third lens 182 is disposed between the second prism 181 and the tube lens 183. The third lens 182 transmits the light from the second prism 181 to the tube lens 183.

The tube lens 183 is disposed between the third lens 182 and the first mirror 184. The tube lens 183 focuses an image of the first alignment mark of the first object 20 and the image of the second alignment mark of the second object 30.

The first mirror 184 is disposed between the tube lens 183 and the fourth polarization beam splitter 185. The first mirror 184 reflects the light passing through the tube lens 183 to be transmitted to the fourth polarization beam splitter 185.

The fourth polarization beam splitter 185 is disposed between the first mirror 184 and the first light detector 190. The fourth polarization beam splitter 185 separates the lights and transmits each separated light to the first light detector 190.

The first light detector 190 detects a first image information 191 for the first alignment mark of the first object 20 and a second image information 192 for the second alignment mark of the second object 30 included in the lights. In an embodiment, the first light detector 190 may include an image sensor.

The parallelism optical system 200 may include a light source 210, a first polarizer 211, a second mirror 212, a second polarization beam splitter 220, a third wavelength plate 231, a first reflection mirror 232, a fourth wavelength plate 241, a first dichroic mirror 161, a folding mirror 170, a third polarization beam splitter 250, a fifth wavelength plate 261, a second reflection mirror 262, a sixth wavelength plate 271, a second dichroic mirror 162, a third mirror 281, a second polarizer 282, and a second light detector 290.

The light source 210 generates a coherent light (C0; referring to FIG. 5). The light source 210 may include a light guide member that guides the coherent light C0 and a collimator lens for converting the coherent light C0 into a parallel light. As the parallel light, the coherent light C0 may have a diameter of several to tens of millimeters (mm). In an embodiment, the coherent light C0 may include a second wavelength 22 that is different from the first wavelength 21.

The first polarizer 211 is disposed between the light source 210 and the second mirror 212. The first polarizer 211 converts the coherent light C0 into the linear polarization (C1; referring to FIG. 5) in a 45° direction. The first polarizer 211 blocks components polarized at a right angle to the linear polarization C1 among the components of the coherent light C0.

The second mirror 212 is disposed between the first polarizer 211 and the second polarization beam splitter 220. The second mirror 212 reflects the linear polarization C1 that has passed through the first polarizer 211 to be transmitted to the second polarization beam splitter 220.

The second polarization beam splitter 220 is disposed between the second mirror 212 and the third polarization beam splitter 250 in the X direction (the first horizontal direction), and between the third wavelength plate 231 and the fourth wavelength plate 241 in the Z direction (the second horizontal direction; −Z direction is also defined as the Z direction). The second polarization beam splitter 220 transmits the P polarization (the horizontal direction component) and reflects the S polarization (the vertical direction component). The second polarization beam splitter 220 splits the linear polarization C1 into the reference light (R; referring to FIG. 5) and the measuring light (M; referring to FIG. 5), transmits the reference light R to the third polarization beam splitter 250, transmits the measuring light M to be incident to the first object 20 to the third wavelength plate 231, and transmits the measuring light M reflected from the first object 20 to the third polarization beam splitter 250.

The third wavelength plate 231 is disposed on the first surface 220A of the second polarization beam splitter 220. The third wavelength plate 231 is disposed between the second polarization beam splitter 220 and the first reflection mirror 232. The third wavelength plate 231 generates a phase delay between the ordinary axis and the extraordinary axis of measuring light M passing through the third wavelength plate 231. The third wavelength plate 231 converts the polarization state of the measuring light M passing through the third wavelength plate 231. For the third wavelength plate 231, the fast axis may be set to a 45° direction, or the slow axis may be set to a 45° direction. In an embodiment, the third wavelength plate 231 may include a ¼ wavelength plate.

The first reflection mirror 232 is disposed on the third wavelength plate 231 in the Z direction (the second horizontal direction). The first reflection mirror 232 reflects the measuring light M that has passed through the third wavelength plate 231 to be transmitted to the third wavelength plate 231.

The fourth wavelength plate 241 is disposed on the second surface 220B, which is the opposite side of the first surface 220A of the second polarization beam splitter 220. The fourth wavelength plate 241 is disposed between the second polarization beam splitter 220 and the first dichroic mirror 161. The fourth wavelength plate 241 generates a phase delay between the ordinary axis and the extraordinary axis of the measuring light M passing through the fourth wavelength plate 241. The fourth wavelength plate 241 converts the polarization state of measuring light M passing through the fourth wavelength plate 241. For the fourth wavelength plate 241, the fast axis may be set to a 45° direction, or the slow axis may be set to a 45° direction. In an embodiment, the fourth wavelength plate 241 may include a ¼ wavelength plate.

The first dichroic mirror 161 is disposed on the fourth wavelength plate 241 in the Z direction (the second horizontal direction). The dichroic mirror may selectively reflect light in a predetermined wavelength region, so using the dichroic mirror may separate light according to a wavelength. The first dichroic mirror 161 reflects the measuring light M with the second wavelength λ2.

The folding mirror 170 reflects the measuring light M reflected from the first dichroic mirror 161 in the vertical lower direction to be directed to the first object 20, and transmits the measuring light M reflected from the first dichroic mirror 161 to the first dichroic mirror 161. The folding mirror 170 converts the optical axis of the measuring light M incident on the folding mirror 170 by 90°.

The third polarization beam splitter 250 is disposed on the third surface 220C, which is an adjacent surface of the first surface 220A of the second polarization beam splitter 220. The third polarization beam splitter 250 is disposed between the second polarization beam splitter 220 and the third mirror 281 in the X direction (the first horizontal direction), and between the fifth wavelength plate 261 and the sixth wavelength plate 271 in the Z direction (the second horizontal direction). The third polarization beam splitter 250 transmits the P polarization (the horizontal direction component) and reflects the S polarization (the vertical direction component). The third polarization beam splitter 250 transmits the reference light R to be transmitted to the third mirror 281, reflects the measuring light M transmitted from the second polarization beam splitter 220 to be transmitted to the sixth wavelength plate 271, and transmits the measuring light M reflected from the second object 30 to the third mirror 281.

The fifth wavelength plate 261 is disposed on the first surface 250A of the third polarization beam splitter 250. The fifth wavelength plate 261 is disposed between the third polarization beam splitter 250 and the second reflection mirror 262. The fifth wavelength plate 261 generates a phase delay between the ordinary axis and the extraordinary axis of the measuring light M passing through the fifth wavelength plate 261. The fifth wavelength plate 261 converts the polarization state of the measuring light M passing through the fifth wavelength plate 261. For the fifth wavelength plate 261, the fast axis may be set to a 45° direction, or the slow axis may be set to a 45° direction. In an embodiment, the fifth wavelength plate 261 may include a ¼ wavelength plate.

The second reflection mirror 262 is disposed on the fifth wavelength plate 261 in the Z direction (the second horizontal direction). The second reflection mirror 262 reflects the measuring light M that has passed through the fifth wavelength plate 261 to be transmitted to the fifth wavelength plate 261.

The sixth wavelength plate 271 is disposed on the second surface 250B, which is the opposite side of the first surface 220A of the third polarization beam splitter 250. The sixth wavelength plate 271 is disposed between the third polarization beam splitter 250 and the second dichroic mirror 162. The sixth wavelength plate 271 generates a phase delay between the ordinary axis and the extraordinary axis of the measuring light M passing through the sixth wavelength plate 271. The sixth wavelength plate 271 changes the polarization state of the measuring light M passing through the sixth wavelength plate 271. For the sixth wavelength plate 271, the fast axis may be set to a 45° direction, or the slow axis may be set to a 45° direction. In an embodiment, the sixth wavelength plate 271 may include a ¼ wavelength plate.

The second dichroic mirror 162 is disposed on the sixth wavelength plate 271 in the Z direction (the second horizontal direction). The dichroic mirror may selectively reflect light in a predetermined wavelength region, so using the dichroic mirror may separate light according to a wavelength. The second dichroic mirror 162 reflects the measuring light M with a second wavelength λ2.

The folding mirror 170 reflects the measuring light M reflected from the second dichroic mirror 162 in the vertical upper direction to be directed to the second object 30, and transmits the measuring light M reflected from the second object 30 to the second dichroic mirror 162. The folding mirror 170 converts the optical axis of the measuring light M incident on the folding mirror 170 by 90°.

The third mirror 281 is disposed between the third polarization beam splitter 250 and the second polarizer 282. The third mirror 281 reflects the reference light R and the measuring light M emitted from the third surface 250C adjacent to the first surface 250A of the third polarization beam splitter 250 to be transmitted to the second polarizer 282.

The second polarizer 282 is disposed between the third mirror 281 and the second light detector 290. The second polarizer 282 interferes the reference light R and the measuring light M with each other.

The second light detector 290 detects the interference pattern of the reference light R and the measuring light M emitted from the second polarizer 282. In an embodiment, the second light detector 290 may include an image device for detecting the interference pattern of the reference light R and the measuring light M.

FIG. 3 is a view showing an imaging optical system according to an embodiment. In FIG. 3, the image measuring process according to the light path of the imaging optical system 100 is explained.

Referring to FIG. 3, the illumination light L may have a light path that passes through the illumination element 110, the lens 111, the first prism 112, and the third prism 122 and reaches the polarization beam splitting surface 121. In an embodiment, the illumination light L may be in a non-polarization (i.e., unpolarized) state. In an embodiment, the illumination light L may have a first wavelength 21. The illumination light L is emitted from the illumination element 110, passes through the lens 111 and the first prism 112, and enters the first surface of the third prism 122. The illumination light L may be incident on the first surface of the third prism 122 so that the optical axis of the illumination light L is orthogonal. Subsequently, the illumination light L passes through the third prism 122 and reaches the polarization beam splitting surface 121. The non-polarization illumination light L that reaches the polarization beam splitting surface 121 is divided into a first illumination light L1 with the P polarization (the horizontal direction component) and a second illumination light L2 with the S polarization (the vertical direction component). The first illumination light L1 with the P polarization (the horizontal direction component) transmits the polarization beam splitting surface 121, and the second illumination light L2 with the S polarization (the vertical direction component) is reflected from the polarization beam splitting surface 121.

The first illumination light L1 transmitted through the polarization beam splitting surface 121 may have a first light path that passes through the fourth prism 123, the first reflection unit 131, the first wavelength plate 141, the first lens 151, the first dichroic mirror 161, the folding mirror 170, the first object 20, the folding mirror 170, the first dichroic mirror 161, the first lens 151, the first wavelength plate 141, the first reflection unit 131, and the fourth prism 123, and reaches the polarization beam splitting surface 121.

The first illumination light L1 that passes through the polarization beam splitting surface 121 passes through the fourth prism 123 and is emitted through the third surface of the fourth prism 123. The first illumination light L1 emitted from the fourth prism 123 is incident on the first reflection unit 131 and reflected from the first reflection unit 131. The first illumination light L1 reflected from the first reflection unit 131 reaches the first wavelength plate 141. As the first illumination light L1 passes through the first wavelength plate 141, a phase thereof is delayed by π/2 radians. The polarization state of the first illumination light L1 is converted to a circular polarization. The first illumination light L1, which passes through the first wavelength plate 141, reaches the first lens 151. The first illumination light L1 that reaches the first lens 151 is collected in the first lens 151 and transmitted to the first dichroic mirror 161. Since the first illumination light L1 that reaches the first dichroic mirror 161 has the first wavelength 21, it passes through the first dichroic mirror 161. The first illumination light L1 passed through the first dichroic mirror 161 reaches the folding mirror 170. For the first illumination light L1 that reaches the folding mirror 170, the optical axis is converted by 90° by the folding mirror 170. The first illumination light L1 that reaches the folding mirror 170 is reflected in the vertical lower direction by the folding mirror 170 and is incident on the first object 20.

The first illumination light L1 incident on the first object 20 has an image information about the first alignment mark of the first object 20 and is reflected from the first object 20. The first illumination light L1 reflected from the first object 20 reaches the folding mirror 170. The first illumination light L1 that reaches the folding mirror 170 has the optical axis converted by 90° by the folding mirror 170. The first illumination light L1 that reaches the folding mirror 170 is reflected by the folding mirror 170 in the first dichroic mirror 161 direction and reaches the first dichroic mirror 161. Since the first illumination light L1 that reaches the first dichroic mirror 161 has the first wavelength 21, it passes through the first dichroic mirror 161. The first illumination light L1 that passes through the first dichroic mirror 161 passes through the first lens 151 and reaches the first wavelength plate 141. As the first illumination light L1 passes through the first wavelength plate 141, the phase thereof is delayed by π/2 radians. The polarization state of the first illumination light L1 is converted to the S polarization (the vertical direction component), which is a linear polarization. The first illumination light L1 passing through the first wavelength plate 141 is incident on the first reflection unit 131 and reflected in the fourth prism 123 direction. The first illumination light L1 reflected from the first reflection unit 131 is incident on the fourth prism 123 through the third surface of the fourth prism 123 and reaches the polarization beam splitting surface 121. The first illumination light L1 with the S polarization (the vertical direction component) is reflected from the polarization beam splitting surface 121 and directed to the second prism 181.

The second illumination light L2 reflected from the polarization beam splitting surface 121 may have a second light path that passes through the third prism 122, the second reflection unit 132, the second wavelength plate 142, the second lens 152, the second dichroic mirror 162, the folding mirror 170, the second object 30, the folding mirror 170, the second dichroic mirror 162, the second lens 152, the second wavelength plate 142, the second reflection unit 132, and the third prism 122, and reaches the polarization beam splitting surface 121. The folding mirror 170 may be shared on the first light path of the first illumination light L1 and the second light path of the second illumination light L2. That is, the folding mirror 170 (as well as the first dichroic mirror 161 and the second dichroic mirror 162, as described below) may be positioned or arranged so as to be located in both (i) the first light path of the first illumination light L1, and (ii) the second light path of the second illumination light L2. Such an arrangement may also be referred to herein as being shared with or common to the first and second optical systems 100 and 200.

The second illumination light L2 reflected from the polarization beam splitting surface 121 passes through the third prism 122 and is emitted through the third surface of the third prism 122. The second illumination light L2 emitted from the third prism 122 is incident on the second reflection unit 132 and reflected from the second reflection unit 132. The second illumination light L2 reflected from the second reflection unit 132 reaches the second wavelength plate 142. As the second illumination light L2 passes through the second wavelength plate 142, the phase thereof is delayed by π/2 radians. The polarization state of the second illumination light L2 is converted to a circular polarization. The second illumination light L2 passing through the second wavelength plate 142 reaches the second lens 152. The second illumination light L2 that reaches the second lens 152 is collected in the second lens 152 and transmitted to the second dichroic mirror 162. The second illumination light L2 that reaches the second dichroic mirror 162 has a first wavelength 21, so it transmits through the second dichroic mirror 162. The second illumination light L2 passed through the second dichroic mirror 162 reaches the folding mirror 170. For the second illumination light L2 that reaches the folding mirror 170, the optical axis is converted by 90° by the folding mirror 170. The second illumination light L2 that reaches the folding mirror 170 is reflected in the vertical upper direction by the folding mirror 170 and is incident on the second object 30.

The second illumination light L2 incident on the second object 30 has an image information about the second alignment mark of the second object 30 and is reflected from the second object 30. The second illumination light L2 reflected from the second object 30 reaches the folding mirror 170. The second illumination light L2 that reaches the folding mirror 170 has the optical axis converted by 90° by folding mirror 170. The second illumination light L2 that reaches folding mirror 170 is reflected by the folding mirror 170 in the direction of the second dichroic mirror 162 and reaches the second dichroic mirror 162. The second illumination light L2 that reaches the second dichroic mirror 162 has a first wavelength 21, so it transmits through second dichroic mirror 162. The second illumination light L2 passing through the second dichroic mirror 162 passes through the second lens 152 and reaches the second wavelength plate 142. As the second illumination light L2 passes through the second wavelength plate 142, the phase thereof is delayed by π/2 radians. The polarization state of the second illumination light L2 is converted to the P polarization (the horizontal direction component), which is a linear polarization. The second illumination light L2 passing through the second wavelength plate 142 is incident on the second reflection unit 132 and reflected in the third prism 122 direction. The second illumination light L2 reflected from the second reflection unit 132 is incident on the third prism 122 through the third surface of the third prism 122 and reaches the polarization beam splitting surface 121. The second illumination light L2 with the P polarization (the horizontal direction component) passes through the polarization beam splitting surface 121 and is directed to the second prism 181.

The first illumination light L1 reflected from the polarization beam splitting surface 121 and the second illumination light L2 transmitted through polarization beam splitting surface 121 may have a common light path that passes through the fourth prism 123, the second prism 181, the third lens 182, the tube lens 183, the first mirror 184, and the fourth polarization beam splitter 185, and reaches the first light detector 190.

The first illumination light L1 reflected from the polarization beam splitting surface 121 and the second illumination light L2 transmitted through polarization beam splitting surface 121 passes through the fourth prism 123 and are incident to the second prism 181. The first illumination light L1 and the second illumination light L2 incident on the second prism 181 are totally internally reflected within the second prism 181 and pass through the second prism 181. Subsequently, the first illumination light L1 and the second illumination light L2 pass through the third lens 182, the tube lens 183, and the first mirror 184 and reach the fourth polarization beam splitter 185. The fourth polarization beam splitter 185 separates the first illumination light L1 and the second illumination light L2. The first illumination light L1 with the P polarization (the vertical direction component) passes through the fourth polarization beam splitter 185 and is transmitted to the first light detector 190. The second illumination light L2 with the S polarization (the horizontal direction component) is reflected from the fourth polarization beam splitter 185 and transmitted to the first light detector 190.

The first image information 191 for the first alignment mark of the first object 20 included in the first illumination light L1 and the second image information 192 for the second alignment mark of the second object 30 included in the second illumination light L2 are detected by the first light detector 190. By comparing the first image information 191 and the second image information 192, the relative positions of the first alignment mark of the first object 20 and the second alignment mark of the second object 30 may be detected.

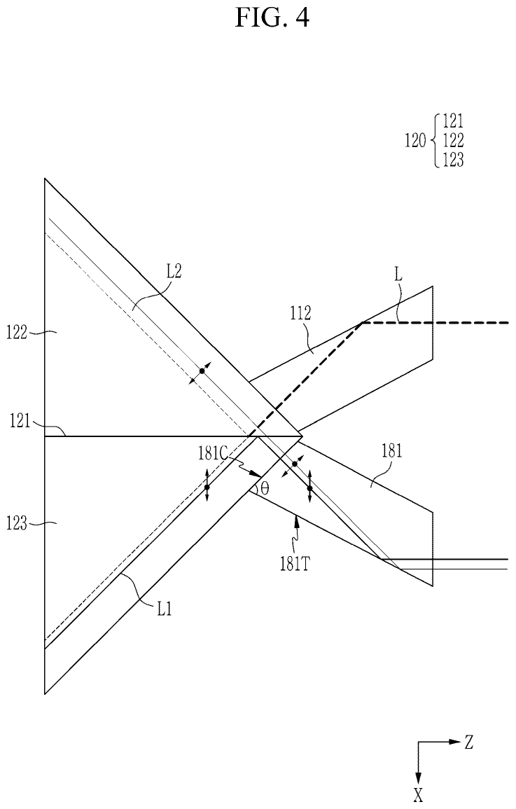

FIG. 4 is a view showing an arrangement of a first polarization beam splitter 120 and a second prism 181 of an imaging optical system 100.

Referring to FIG. 4, the second prism 181 is in contact with the fourth prism 123 of the first polarization beam splitter 120, and includes a light receiving surface 181C on which a first illumination light L1 and a second illumination light L2 are incident, and a total reflection surface 181T on which the first illumination light L1 and the second illumination light L2 are respectively totally reflected within the second prism 181. The total reflection surface 181T totally (internally) reflects the first illumination light L1 while maintaining the polarization state of the first illumination light L1, and totally (internally) reflects the second illumination light L2 while maintaining the polarization state of the second illumination light L2. An angle θ between the light receiving surface 181C and the total reflection surface 181T may have an angle that may maintain the polarization state of the first illumination light L1 before being reflected from the total reflection surface 181T even after being reflected from the total reflection surface 181T, and the polarization state of the second illumination light L2 before being reflected from the total reflection surface 181T even after being reflected from the total reflection surface 181T. The angle θ between the light receiving surface 181C and the total reflection surface 181T is set so that the first illumination light L1 with the S polarization (the vertical direction component) incident on the second prism 181 does not become an elliptical polarization and maintains the S polarization (the vertical direction component), and the second illumination light L2 with the P polarization (the horizontal direction component) incident on the second prism 181 does not become an elliptical polarization and maintains the P polarization (the horizontal direction component). In an embodiment, the angle θ between the light receiving surface 181C and the total reflection surface 181T may be about 67.5°.

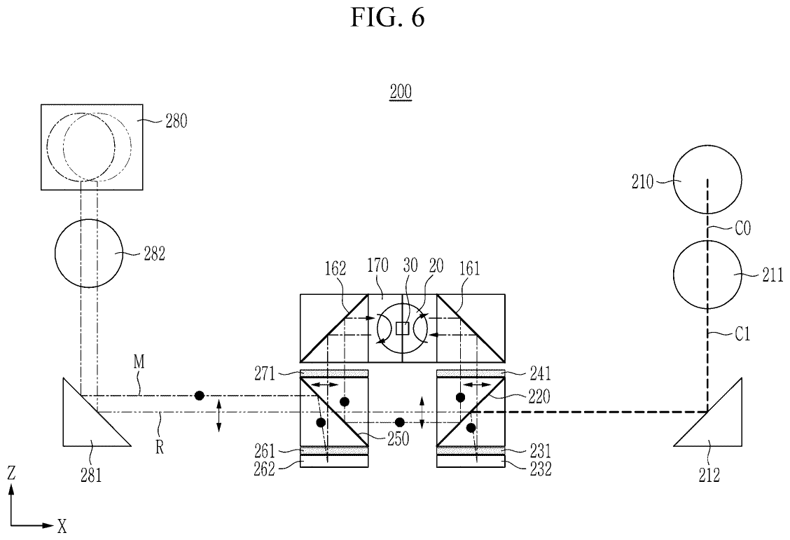

FIG. 5 is a view showing a parallelism optical system 200 according to an embodiment. FIG. 6 is a top plan view showing a parallelism optical system 200 according to an embodiment. In FIG. 5 and FIG. 6, a parallelism measuring process according to the light path of the parallelism optical system 200 is described.

Referring to FIG. 5 and FIG. 6, a coherent light C0 is converted into a linear polarization C1 while passing through a first polarizer 211. In an embodiment, the coherent light C0 and the linear polarization C1 may have a second wavelength 22. The linear polarization C1 passes through the second mirror 212 and reaches the second polarization beam splitter 220. The linear polarization C1 may be a synthesis light including a horizontal direction component and a vertical direction component. The linear polarization C1 that reaches the second polarization beam splitter 220 is split into a reference light R with the P polarization (the horizontal direction component) and a measuring light M with the S polarization (the vertical direction component). The reference light R with the P polarization (the horizontal direction component) passes through the second polarization beam splitter 220 and is transmitted to the third polarization beam splitter 250, and the measuring light M with the S polarization (the vertical direction component) is reflected from the second polarization beam splitter 220 toward the third wavelength plate 231. In an embodiment, the reference light R and the measuring light M may have a second wavelength λ2.

The reference light R passing through the second polarization beam splitter 220 reaches the third polarization beam splitter 250. The reference light R with the P polarization (the horizontal direction component) that reaches the third polarization beam splitter 250 passes through the third polarization beam splitter 250 and reaches the third mirror 281.

The measuring light M reflected from the second polarization beam splitter 220 may have a third light path that passes through the third wavelength plate 231, the first reflection mirror 232, the third wavelength plate 231, the second polarization beam splitter 220, the fourth wavelength plate 241, the first dichroic mirror 161, the folding mirror 170, the first object 20, the folding mirror 170, the first dichroic mirror 161, the fourth wavelength plate 241, the second polarization beam splitter 220, the third polarization beam splitter 250, the sixth wavelength plate 271, the second dichroic mirror 162, the folding mirror 170, the second object 30, the folding mirror 170, the second dichroic mirror 162, the sixth wavelength plate 271, the third polarization beam splitter 250, the fifth wavelength plate 261, the second reflection mirror 262, and the fifth wavelength plate 261, and reaches the third polarization beam splitter 250. The first dichroic mirror 161, the second dichroic mirror 162, and the folding mirror 170 may be included in the parallelism optical system 200 on the third path of measuring light M, and may be included in the imaging optical system 100 on the first light path of first illumination light L1 and on the second light path of second illumination light L2. The first dichroic mirror 161, the second dichroic mirror 162, and the folding mirror 170 may be shared in the imaging optical system 100 and the parallelism optical system 200 (that is, included in the respective light paths thereof). Since the measuring light M does not pass through the lens in the third light path, the area of the measuring light M in the third light path may be constantly or uniformly maintained.

The measuring light M reflected from the second polarization beam splitter 220 reaches the third wavelength plate 231. The measuring light M, which reaches the third wavelength plate 231, passes through the third wavelength plate 231. As the measuring light M passes through the third wavelength plate 231, the phase thereof is delayed by π/2 radians. The polarization state of the measuring light M is converted to a circular polarization. The measuring light M passing through the third wavelength plate 231 is reflected from the first reflection mirror 232 and reaches the third wavelength plate 231 again. The measuring light M, which reaches the third wavelength plate 231, passes through the third wavelength plate 231. As the measuring light M passes through the third wavelength plate 231, a phase thereof is delayed by π/2 radians. The polarization state of the measuring light M is converted to the P polarization (the horizontal direction component), which is a linear polarization. The measuring light M, passing through the third wavelength plate 231, reaches the second polarization beam splitter 220. The measuring light M that reaches the second polarization beam splitter 220 has the P polarization (the horizontal direction component) and therefore passes through the second polarization beam splitter 220. The measuring light M passing through the second polarization beam splitter 220 reaches the fourth wavelength plate 241. The measuring light M, which reaches the fourth wavelength plate 241, passes through the fourth wavelength plate 241. As the measuring light M passes through the fourth wavelength plate 241, a phase thereof is delayed by π/2 radians. The polarization state of the measuring light M is converted to a circular polarization. The measuring light M, passing through the fourth wavelength plate 241, reaches the first dichroic mirror 161. Because the measuring light M that reaches the first dichroic mirror 161 has a second wavelength 22, it is reflected from the first dichroic mirror 161 toward the folding mirror 170. The measuring light M reflected from first dichroic mirror 161 reaches folding mirror 170. The measuring light M that reaches the folding mirror 170 has an optical axis rotated or converted by 90° by the folding mirror 170. The measuring light M that reaches folding mirror 170 is reflected in the vertical lower (e.g., negative Z−) direction by the folding mirror 170 and is incident on the first object 20.

The measuring light M incident on the first object 20 has a first information about the surface of the first object 20 and is reflected from the first object 20. The measuring light M reflected from the first object 20 reaches the folding mirror 170. The measuring light M that reaches the folding mirror 170 has an optical axis rotated or converted by 90° by the folding mirror 170. The measuring light M that reaches the folding mirror 170 is reflected toward the first dichroic mirror 161 by the folding mirror 170 and reaches the first dichroic mirror 161. Because the measuring light M that reaches the first dichroic mirror 161 has a second wavelength 22, it is reflected from the first dichroic mirror 161 toward the fourth wavelength plate 241. The measuring light M reflected from the first dichroic mirror 161 reaches the fourth wavelength plate 241. The measuring light M, which reaches the fourth wavelength plate 241, passes through the fourth wavelength plate 241. As the measuring light M passes through the fourth wavelength plate 241, a phase is delayed by π/2 radians. The polarization state of the measuring light M is converted into the S polarization (the vertical direction component), which is a linear polarization. The measuring light M passing through the fourth wavelength plate 241 reaches the second polarization beam splitter 220. Since the measuring light M that reaches the second polarization beam splitter 220 has the S polarization (the vertical direction component), it is reflected from the second polarization beam splitter 220 toward the third polarization beam splitter 250.

The measuring light M reflected from the second polarization beam splitter 220 reaches the third polarization beam splitter 250. The measuring light M that reaches the third polarization beam splitter 250 has the S polarization (the vertical direction component), so it is reflected from the third polarization beam splitter 250 toward the sixth wavelength plate 271. The measuring light M reflected from the third polarization beam splitter 250 reaches the sixth wavelength plate 271. The measuring light M, which reaches the sixth wavelength plate 271, passes through the sixth wavelength plate 271. As the measuring light M passes through the sixth wavelength plate 271, a phase is delayed by π/2 radians. The polarization state of the measuring light M is converted to a circular polarization. The measuring light M, passing through the sixth wavelength plate 271, reaches the second dichroic mirror 162. Because the measuring light M that reaches the second dichroic mirror 162 has a second wavelength 22, it is reflected from the second dichroic mirror 162 toward the folding mirror 170. The measuring light M reflected from the second dichroic mirror 162 reaches the folding mirror 170. The measuring light M that reaches the folding mirror 170 has an optical axis rotated or converted by 90° by the folding mirror 170. The measuring light M that reaches the folding mirror 170 is reflected in the vertical upper (e.g., positive Z−) direction by the folding mirror 170 and is incident on the second object 30.

The measuring light M incident on the second object 30 has a second information about the surface of the second object 30 and is reflected from the second object 30. In an embodiment, the second information may include an information such as a relative parallelism or a relative deformation (a relative warpage) with respect to the first information. The measuring light M reflected from the second object 30 reaches the folding mirror 170. The measuring light M that reaches the folding mirror 170 has an optical axis rotated or converted by 90° by the folding mirror 170. The measuring light M reaching the folding mirror 170 is reflected toward the second dichroic mirror 162 by the folding mirror 170 and reaches the second dichroic mirror 162. Because the measuring light M that reaches the second dichroic mirror 162 has a second wavelength 22, it is reflected from the second dichroic mirror 162 toward the sixth wavelength plate 271. The measuring light M reflected from the second dichroic mirror 162 reaches sixth wavelength plate 271. The measuring light M, which reaches the sixth wavelength plate 271, passes through the sixth wavelength plate 271. As the measuring light M passes through the sixth wavelength plate 271, a phase is delayed by π/2 radians. The polarization state of the measuring light M is converted to the P polarization (the horizontal direction component), which is a linear polarization. The measuring light M, passing through the sixth wavelength plate 271, reaches the third polarization beam splitter 250. The measuring light M that reaches the third polarization beam splitter 250 has a P polarization (a horizontal direction component) and therefore passes through the third polarization beam splitter 250. The measuring light M transmitted through the third polarization beam splitter 250 reaches the fifth wavelength plate 261. The measuring light M, which reaches the fifth wavelength plate 261, passes through the fifth wavelength plate 261. As the measuring light M passes through the fifth wavelength plate 261, a phase is delayed by π/2 radians. The polarization state of the measuring light Mis converted to a circular polarization. The measuring light M passing through the fifth wavelength plate 261 is reflected from the second reflection mirror 262 and reaches the fifth wavelength plate 261 again. The measuring light M, which reaches the fifth wavelength plate 261, passes through the fifth wavelength plate 261. As the measuring light M passes through the fifth wavelength plate 261, a phase is delayed by π/2 radians. The polarization state of the measuring light M is converted to a S polarization (a vertical direction component), which is a linear polarization. The measuring light M passing through the fifth wavelength plate 261 reaches the third polarization beam splitter 250. The measuring light M that reaches the third polarization beam splitter 250 has a S polarization (a vertical direction component), so it is reflected from the third polarization beam splitter 250 toward the third mirror 281.

The reference light R transmitted through the third polarization beam splitter 250 and the measuring light M reflected from the third polarization beam splitter 250 are emitted from the third surface 250C adjacent to the first surface 250A of the third polarization beam splitter 250. The reference light R and the measuring light M emitted from the third polarization beam splitter 250 may have a common light path that passes through the third mirror 281 and the second polarizer 282 and reaches the second light detector 290.

The reference light R transmitted through the third polarization beam splitter 250 and the measuring light M reflected from the third polarization beam splitter 250 pass through the third mirror 281 and reach the second polarizer 282. The reference light R and the measuring light M that reach the second polarizer 282 interfere with each other as they pass through the second polarizer 282. The reference light R and the measuring light M that pass through the second polarizer 282 reach the second light detector 290.

The reference light R and the measuring light M that reach the second light detector 290 are expressed as an interference pattern and are detected by the second light detector 290. By analyzing the interference pattern detected by the second light detector 290, an information such as the parallelism between the first object 20 and the second object 30 or a deformation (e.g., a warpage) of the second object 30 with respect to the first object 20 may be obtained. The parallelism between the first object 20 and the second object 30 or the deformation of the second object 30 for the first object 20 may be obtained by calculating a wavefront of the interference pattern detected by applying a fast Fourier transform (FFT) algorithm. In another embodiment, the parallelism between the first object 20 and the second object 30 or the deformation of the second object 30 for the first object 20 may be obtained by passing the reference light R and the measuring light M through a ¼ wavelength plate, detecting four interference patterns with phase shifts by 90° each by using a polarization camera, and calculating the wavefronts of the four detected interference patterns.

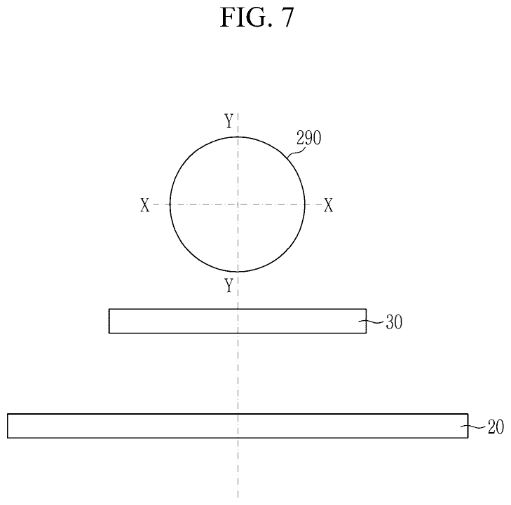

FIG. 7 to FIG. 11 are views showing measuring results of a parallelism optical system 200 according to an embodiment.

Referring to FIG. 7, if the first object 20 and the second object 30 are aligned in parallel, and there is no deformation of the second object 30 with respect to the first object 20, the interference pattern does not appear.

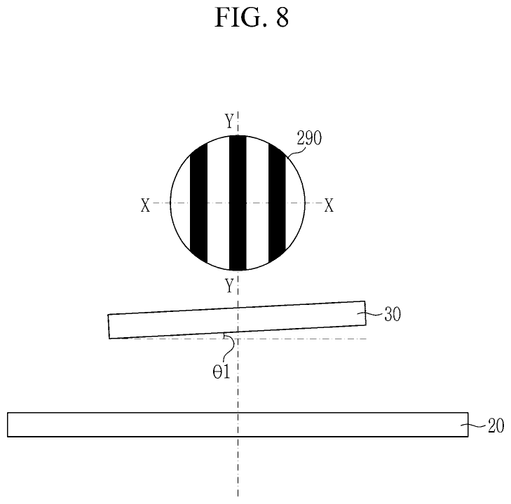

Referring to FIG. 8, if the second object 30 is tilted with a first angle θ1 with respect to the first object 20, and there is no deformation of the second object with respect to first object 20, an interference pattern extending in the Y-Y direction appears.

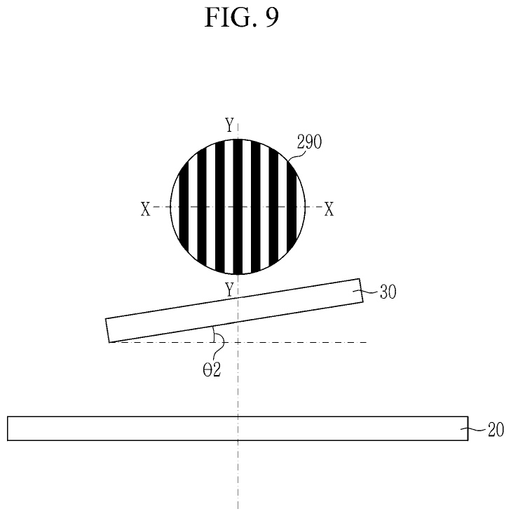

Referring to FIG. 9, if the second object 30 is tilted with a second angle θ2 greater than the first angle θ1 with respect to the first object 20, and there is no deformation in the second object with respect to the first object 20, an interference pattern that extends in the Y-Y direction and is more densely arranged than the interference pattern in FIG. 8 appears.

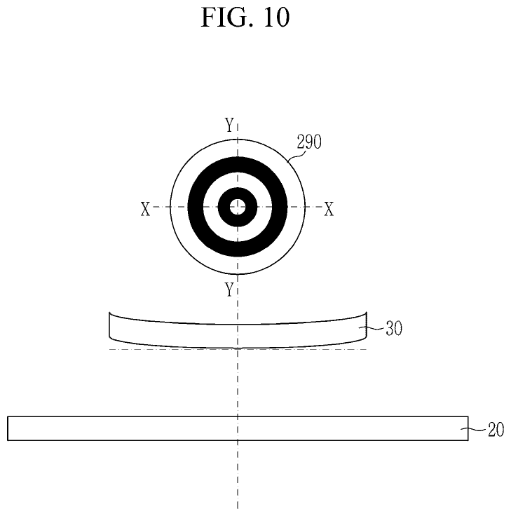

Referring to FIG. 10, when the first object 20 and the second object 30 are aligned in parallel, and there is a spherical deformation of the second object 30 with respect to the first object 20, a centrifugal or concentric interference pattern appears.

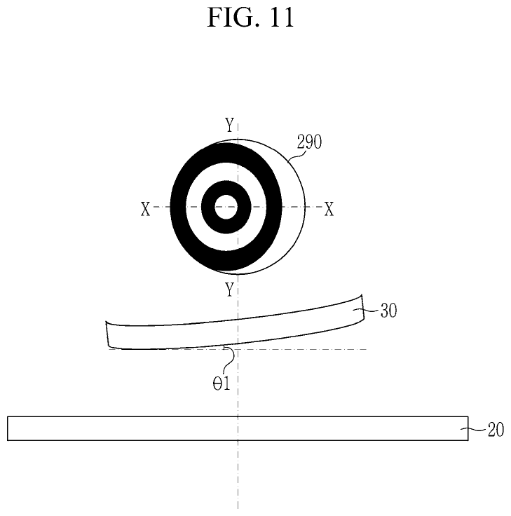

Referring to FIG. 11, when the second object 30 is tilted with the first angle θ1 with respect to the first object 20, and there is a spherical deformation of the second object 30 with respect to the first object 20, an interference pattern with a distorted centrifugal or concentric shape appears.

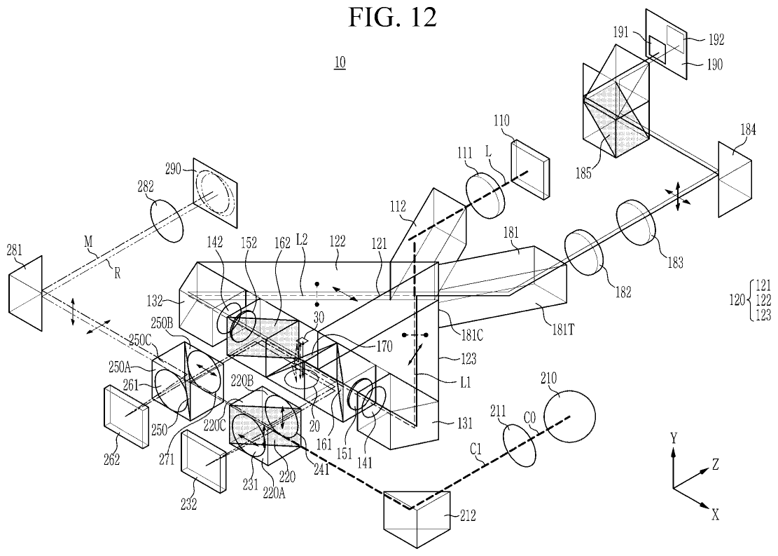

FIG. 12 is a view showing an imaging optical system 100 and a parallelism optical system 200 according to an embodiment.

Referring to FIG. 12, by using the imaging optical system 100 and the parallelism optical system 200, an alignment measurement between the first object 20 and the second object 30 and a parallelism measurement of the first object 20 and the second object 30 may be performed. The optical measuring device 10 including the imaging optical system 100 and the parallelism optical system 200 is disposed between the first object 20 and the second object 30, which are respectively disposed at fixed positions, and the parallelism, the first alignment mark of the first object 20, and the second alignment mark of the second object 30 may be measured simultaneously between the first object 20 and the second object 30 whose position is fixed with respect to the first object 20. The term “simultaneously” as used herein may not require exact coincidence of the described measurements, and thus, may include measurements that are substantially simultaneous.

According to the present disclosure, the alignment and the parallelism of the first object 20 and the second object 30 may be measured at the same position and simultaneously, thereby shortening the time to measure the alignment and the parallelism. In addition, the alignment and the parallelism of the first object 20 and the second object 30 may be measured without being affected by factors such as a replacement of an optical system, an error in a measuring position, and difference in a measuring time, thereby ensuring a measuring reliability of a high level of the alignment and the parallelism and increasing a bonding accuracy between the first object 20 and the second object 30.

In addition, in some embodiments, the alignment measurement of the first object 20 and the second object 30 may be first performed, and then the parallelism of the first object 20 and the second object 30 may be measured in the state that the first object 20 and the second object 30 are aligned, or the parallelism of the first object 20 and the second object 30 may be first measured, and then the alignment of the first object 20 and the second object 30 may be measured in the state that the first object 20 and the second object 30 are disposed in parallel. In an embodiment, between the first object 20 and the second object 30 whose position is fixed with respect to the first object 20, the first alignment mark of the first object 20 and the second alignment mark of the second object 30 may be measured based on the parallelism between the first object 20 and the second object 30 measured by the parallelism optical system 200. In an embodiment, between the first object 20 and the second object 30 whose position is fixed with respect to the first object 20, the parallelism of the first object 20 and the second object 30 may be measured based on the alignment of the first object 20 and the second object 30 measured by the imaging optical system 100. Therefore, it is possible to operate the optical measuring device 10 according to the situation so as to perform the imaging and parallelism measurements simultaneously or sequentially, in any desired order.

According to the present disclosure, the imaging optical system 100 and the parallelism optical system 200 may share the first dichroic mirror 161, the second dichroic mirror 162, and the folding mirror 170. Between the first dichroic mirror 161 and the folding mirror 170, the optical axis of the first illumination light L1 and the optical axis of the measuring light M may be on the same axis, between the second dichroic mirror 162 and the folding mirror 170, the optical axis of the second illumination light L2 and the optical axis of the measuring light M may be on the same axis. Additionally, the imaging optical system 100 and the parallelism optical system 200 are each designed to have the common light path. Therefore, it is possible to measure the alignment and the parallelism more accurately by minimizing environmental changes such as physical vibration and temperature changes that affect the optical measuring device 10.

According to the present disclosure, the illumination light L used in the imaging optical system 100 of the optical measuring device 10 may be divided into two illumination lights or beams (L1 and L2), and both illumination lights (L1 and L2) may be used to measure the alignment between the first object 20 and the second object 30. As a result, light loss within the imaging optical system 100 may be reduced or minimized, and heat generated within the imaging optical system 100 may be reduced or minimized, thereby increasing the stability of the imaging optical system 100.

According to the present disclosure, regardless of the slope or inclination of the optical measuring device 10, the relative angle of the reference light R and the measuring light M in the parallelism optical system 200 remains constant, the parallelism of the first object 20 and the second object 30 may be measured without considering the slope of the optical measuring device 10.

While this disclosure has been described in connection with exemplary embodiments, it is to be understood that the disclosure is not limited to the disclosed embodiments, but, on the contrary, is intended to cover various modifications and equivalent arrangements included within the scope of the appended claims.

What is claimed is:

1. An optical measuring device comprising:
a first optical system configured to measure a first alignment mark of a first object using a first illumination light, and to measure a second alignment mark of a second object facing the first object using a second illumination light; and
a second optical system configured to measure a parallelism of the first object and the second object using a reference light and a measuring light,
wherein the first optical system comprises:
a first dichroic mirror positioned in a first light path of the first illumination light;
a second dichroic mirror positioned in a second light path of the second illumination light; and
a folding mirror positioned in the first light path and in the second light path, and
wherein the second optical system comprises the first dichroic mirror, the second dichroic mirror, and the folding mirror positioned in a third light path of the measuring light.

2. The optical measuring device of claim 1, wherein the first illumination light and the second illumination light have a first wavelength, and the reference light and the measuring light have a second wavelength that is different from the first wavelength.

3. The optical measuring device of claim 2, wherein the first dichroic mirror and the second dichroic mirror are configured to transmit light of the first wavelength and reflect light of the second wavelength.

4. The optical measuring device of claim 1, wherein the first optical system is configured to measure the first alignment mark and the second alignment mark based on the parallelism measured by the second optical system.

5. The optical measuring device of claim 1, wherein the first optical system and the second optical system are configured to measure the parallelism, the first alignment mark, and the second alignment mark simultaneously.

6. The optical measuring device of claim 1, wherein the second optical system is configured to measure a deformation of the second object with respect to the first object.

7. The optical measuring device of claim 1, wherein the first object comprises a semiconductor wafer, and the second object comprises a semiconductor die.

8. An optical measuring device comprising:
a first optical system configured to measure a first alignment mark of a first object using a first illumination light, and to measure a second alignment mark of a second object facing a first object using a second illumination light; and
a second optical system configured to measure a parallelism of the first object and the second object using a reference light and a measuring light,
wherein the first optical system and the second optical system comprise:
a first dichroic mirror configured to transmit the first illumination light and reflect the measuring light;
a second dichroic mirror configured to transmit the second illumination light and reflect the measuring light; and
a folding mirror between the first dichroic mirror and the second dichroic mirror, wherein the folding mirror is configured to reflect the first illumination light transmitted through the first dichroic mirror toward the first alignment mark, to reflect the second illumination light transmitted through the second dichroic mirror toward the second alignment mark, to reflect the measuring light reflected from the first dichroic mirror toward the first object, and to reflect the measuring light reflected from the second dichroic mirror toward the second object.

9. The optical measuring device of claim 8, wherein the folding mirror is a 45° mirror, and the folding mirror is configured to convert an optical axis of the first illumination light, an optical axis of the second illumination light, and an optical axis of the measuring light by 90°.

10. The optical measuring device of claim 8, wherein the first and second optical systems are configured such that:
between the first dichroic mirror and the folding mirror, an optical axis of the first illumination light and an optical axis of the measuring light are on a same axis; and
between the second dichroic mirror and the folding mirror, an optical axis of the second illumination light and the optical axis of the measuring light are on a same axis.

11. An optical measuring device comprising:
a first optical system configured to measure an alignment of a first object and a second object facing the first object; and
a second optical system configured to measure a parallelism of the first object and the second object,
wherein the first optical system comprises:
an illumination element configured to emit illumination light having a first wavelength;
a first polarization beam splitter configured to split the illumination light into a first illumination light incident on the first object and a second illumination light incident on the second object, and configured to direct the first illumination light reflected from the first object and the second illumination light reflected from the second object into a common light path;
a first reflection unit, a first wavelength plate, a first lens, and a first dichroic mirror positioned in a first light path of the first illumination light;
a second reflection unit, a second wavelength plate, a second lens, and a second dichroic mirror positioned in a second light path of the second illumination light; and
a folding mirror positioned in the first light path of the first illumination light and in the second light path of the second illumination light, and positioned between the first dichroic mirror and the second dichroic mirror,
wherein the second optical system comprises:
a light source configured to emit polarized light having a second wavelength;
a second polarization beam splitter configured to split the polarized light into a reference light and a measuring light, and positioned in a third light path of the measuring light;
a first reflection mirror positioned in the third light path, and on a first surface of the second polarization beam splitter;
a third wavelength plate positioned in the third light path, and between the first surface of the second polarization beam splitter and the first reflection mirror;
the first dichroic mirror positioned in the third light path and on a second surface opposite to the first surface of the second polarization beam splitter, wherein the first dichroic mirror is shared with the first optical system;
a fourth wavelength plate positioned in the third light path, and between the second surface of the second polarization beam splitter and the first dichroic mirror;
the folding mirror positioned in the third light path, wherein the folding mirror is shared with the first optical system;
a third polarization beam splitter positioned in the third light path, and on a third surface adjacent to the first surface of the second polarization beam splitter;
a second reflection mirror positioned in the third light path, and on a first surface of the third polarization beam splitter;
a fifth wavelength plate positioned in the third light path, and between the first surface of the third polarization beam splitter and the second reflection mirror;
the second dichroic mirror positioned in the third light path and on a second surface opposite to the first surface of the third polarization beam splitter, wherein the second dichroic mirror is shared with the first optical system; and
a sixth wavelength plate positioned in the third light path and between the second surface of the third polarization beam splitter and the second dichroic mirror.

12. The optical measuring device of claim 11, wherein the first optical system further comprises:
a prism, a third lens, and a tube lens positioned on the common light path;
a fourth polarization beam splitter positioned on the common light path and configured to separate the first illumination light and the second illumination light; and
a first light detector that is configured to detect the first illumination light and the second illumination light that are separated by the fourth polarization beam splitter.

13. The optical measuring device of claim 12, wherein the prism comprises a total reflection surface, and the total reflection surface is configured to totally internally reflect the first illumination light while maintaining a polarization state of the first illumination light, and totally internally reflect the second illumination light while maintaining a polarization state of the second illumination light.

14. The optical measuring device of claim 13, wherein the prism further comprises a light-receiving surface positioned such that the first illumination light and the second illumination light are incident thereon, and
wherein an angle between the light-receiving surface and the total reflection surface is configured to maintain the polarization state of the first illumination light and the polarization state of the second illumination light.

15. The optical measuring device of claim 11, wherein the first polarization beam splitter is configured to split the illumination light such that the first illumination light comprises a P polarization, and the second illumination light comprises a S polarization.

16. The optical measuring device of claim 11, wherein the second optical system further comprises:
a polarizer configured to interfere a reference light and a measuring light emitted from the third polarization beam splitter; and
a second light detector configured to detect an interference pattern of the reference light and the measuring light passing through the polarizer.

17. The optical measuring device of claim 11, wherein the second polarization beam splitter is configured to split the polarized light into the reference light comprising a P polarization.

18. The optical measuring device of claim 11, wherein the second polarization beam splitter and the third polarization beam splitter are configured to transmit the reference light.

19. The optical measuring device of claim 11, wherein the second optical system is configured such that, on the third light path, an area of the measuring light is substantially constant.

20. The optical measuring device of claim 11, wherein the first, second, third, fourth, fifth, and sixth wavelength plates are configured to convert a polarization state of the measuring light.
